(19) United States
(12) Patent Application Publication
(10) Pub. No.: US 2003/0226703 A1
(43) Pub. Date: Dec. 11, 2003

(54) Seatbelt safety device for vehicles

(76) Inventor: Akira Amemiya, Piscataway, NJ (US)

Correspondence Address: Gerald Levy, Esq., PITNEY, HARDIN, KIPP & SZUCH LLP, 685 Third Avenue, New York, NY, 10017-4024, US

(21) Appl. No.: 10/167,742

(22) Filed: Jun. 11, 2002

(51) Int. Cl. B60R 21/00

(52) U.S. Cl. 180/270

(57) ABSTRACT

A simple but improved seatbelt safety device is provided for preventing vehicles from starting an engine by an engine key without drivers or passengers wearing seatbelts. The seatbelt safety device for a vehicle is placed in an electric circuit for energizing an engine for the vehicle, via an engine starter key for starting the engine. The electric circuit includes a built-in ON/OFF switch seat buckle detector, an occupant's seating detecting ON/OFF switch or sensor in parallel, thereby enabling the engine starter key to start the engine only when an occupant is seated and the seatbelt is fastened.

### FIELD OF THE INVENTION

This invention relates to a seatbelt safety device for vehicles including passenger cars, and more particularly to a seatbelt safety device for preventing vehicles from starting an engine without passengers wearing seatbelts.

### BACKGROUND OF THE INVENTION

Wearing seatbelts is crucial for safety of drivers and passengers in vehicles including passenger cars. In the past, vehicles were allowed to move without occupants wearing seatbelts. Therefore, when an accident happened, people might have lost their lives.

A safety device is needed for preventing the vehicles from starting an engine without confirming wearing of seatbelts by occupants. The applicant of this application has suggested such a seatbelt safety device, as disclosed in his laid-open publications Nos. 1999-321,560 titled “SEATBELTS WITH BUILT-IN SWITCH” (published Nov. 24, 1999) and 2001-287,623 titled “DEVICE FOR PREVENTING MOVING WITHOUT WEARING OF SEATBELTS” (published Oct. 16, 2001). His underlying concept is that a simplest circuit or an arrangement with a minimum of components leads to a best safety or safest device, because the simplest circuit experiences a smallest chance of malfunction or erroneous operation.

Japanese laid-open publication 1995-251,711 (published Oct. 3, 1995) shows and discloses a much complicated seatbelt safety circuit arrangement for preventing a vehicle from start moving when a driver or passenger is seated but a seat belt remains unfastened and the speed of the vehicle remains still zero.

### SUMMARY AND OBJECTS OF THE INVENTION

Accordingly, it is an object of the present invention to provide a seatbelt safety device for preventing vehicles from starting an engine without drivers or passengers wearing seatbelts.

It is another object of the present invention to provide a seatbelt safety device which includes a minimum of components for minimizing risk of malfunction or erroneous operation.

It is still another object of the present invention to provide a seatbelt safety device which allows a vehicle to continue moving, even if a seatbelt is unfastened in the middle of driving, once the vehicle has started to move with confirmation of wearing of a seatbelt by an occupant.

According to the present invention, there is provided an improved seatbelt safety device for preventing vehicles from starting an engine by an engine key without drivers or passengers wearing seatbelts. The seatbelt safety device for a vehicle comprises an engine for the vehicle, an engine starter key for starting the engine, a seatbelt with a built-in ON/OFF switch, an occupant's seating detecting ON/OFF switch or sensor, an electric circuit for connecting the seatbelt ON/OFF switch and the occupant's seating detecting ON/OFF switch or sensor between the engine and the engine starter key for enabling the engine starter key to start the engine only when an occupant is seated and the seatbelt is fastened.

In a preferred embodiment of the present invention, the seatbelt switch is connected in parallel with the occupant's seating detecting switch or sensor. A pair of the seatbelt switch and the occupant's seating switch or sensor is provided for the safety of one driver or passenger.

If necessary or desirable, more than one pair of the seatbelt switch and the occupant's seating detecting switch or sensor is provided for up to the total number of occupants or passengers in the vehicle. All of the seatbelt switches are connected in series, while all of the occupant's seating detecting switches or sensors are also connected in series.

The seatbelt safety device of the present invention further comprises a short circuit between the engine starter key and the engine for allowing the vehicle to continue moving, even if the seatbelt is unfastened in the middle of driving, once the vehicle has started to move with confirmation of wearing of a seatbelt by an occupant. A warning alert may provided by a sound IC to notify the occupants of unfastened seatbelt when the seatbelt is unfastened in the middle of driving.

### BRIEF DESCRIPTION OF DRAWINGS

FIG. 1 is a front view of a seatbelt having a built-in switch for use with a preferred embodiment of the present invention; and

FIG. 2 is a circuit diagram of an electric circuit for a seatbelt safety device according to the preferred embodiment of the present invention.

### DETAILED DESCRIPTION OF THE INVENTION

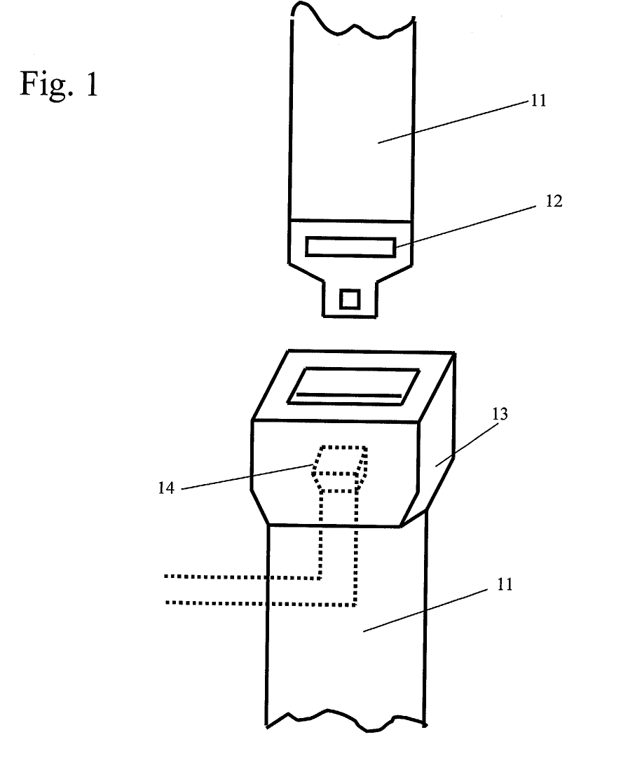

Referring to FIG. 1, there is illustrated a seatbelt having a built-in ON/OFF switch or sensor for use with a preferred embodiment of the present invention. A seatbelt 11 has a belt latch plate 12 which may be fully inserted into a buckle 13. A seat buckle detector (switch or sensor) 14 typically comprises a pressure-sensing bladder or a load-responsive electric ON/OFF switch installed in the interior of the buckle 13. The seat buckle detector 14 indicates an engaged or non-engaged state of the buckle 13 and provides ON and OFF electric signals depending on the seat buckle status. When the belt latch plate 12 is fully inserted into the buckle 13, the detector 14 turns ON and activates an electric circuit as discussed below for a seatbelt safety device according to the preferred embodiment of the present invention. The belt buckle detector 14 remains OFF unless activated with occupant's wearing of the seatbelt. If necessary and desirable, more than one belt buckle detector 14 may be provided and a plurality of the belt buckle detectors 14 may be provided for up to a total number of seatbelts installed in a passenger vehicle. The detector 14 as shown in FIG. 1 are not meant to the limit the invention to any particular type of switch or sensor.

A seat occupancy detector (switch or sensor) 15 is provided to detect whether an occupant is sitting in the seat of the vehicle. Although not shown in the drawings, the seat occupancy detector 15 may be installed inside the seat mat or outside but in the neighborhood of the seat mat to an extent which the switch or sensor may find whether the occupant is sitting in the seat. The seat occupancy detector may be of any conventional type including an electric ON/OFF micro switch or infrared non-contact approach sensor. More than one seat occupancy detector 15 may be provided for more than one occupant. Like the belt buckle switch or sensor 14, the number of the seat occupancy detectors 15 equal to the number of the seats in the vehicle may be provided. When the occupant has sit in the seat in the vehicle, the seat occupancy detectors 15 is activated to disconnect the electric circuit for the seatbelt safety device. Under this condition, an engine of the vehicle will not start even if a starter key is turned ON. It will be noted that the seat occupancy detector 15 is normally ON. However, if the occupant wears the seatbelt 11 to turn ON the seat buckle detector 14 and activate the electric circuit for the seatbelt safety device, the engine is allowed to start.

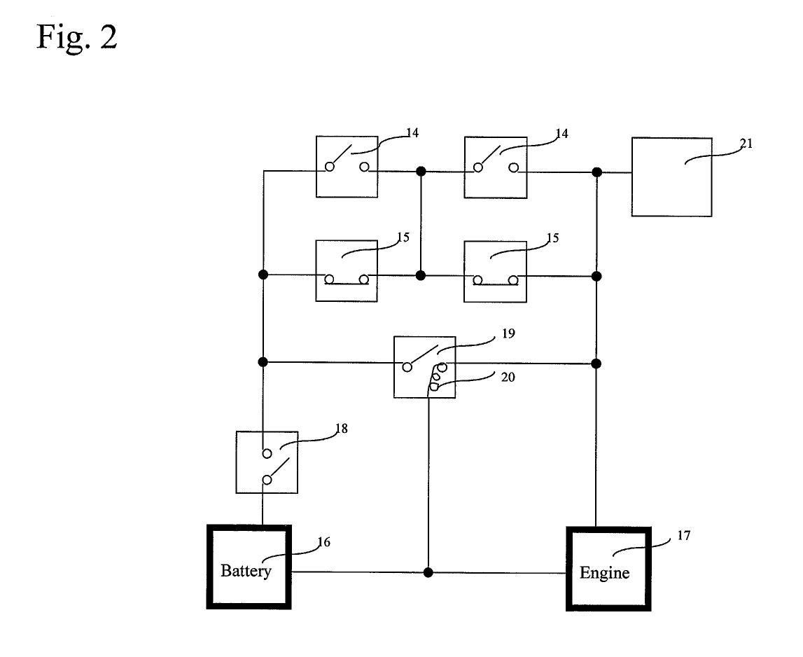

FIG. 2 illustrates the electric circuit for the seatbelt safety device according to the preferred embodiment of the present invention. The illustrated electric circuit for the seatbelt safety device is disposed between an electric battery 16 and the engine 17 for controlling electric supply from the battery 16 to the engine 17, depending upon the status of the belt buckle detectors 14 and the seat occupancy detectors 15. A starter key switch 18 is interposed between the battery 16 and the engine 17. The belt buckle detector 14 and the seat occupancy detector 15 are connected in parallel between the battery 16 and the engine 17. If the plurality of the belt buckle detectors 14 and the seat occupancy detectors 15 are connected in the electric circuit, then all the belt buckle detectors 14 are connected in series between the battery 16 and the engine 17 and all the seat occupancy detectors 15 are also connected in series. Therefore, when all the occupants are sitting in the individual seats in the vehicle and wearing the seatbelts, the power supply from the battery 16 is provided via the belt buckle detectors 14 to power the engine 17.

If no one is sitting in the vehicle (that is, the seat occupancy detector 15 remains ON) but someone turns on the starter key 18, then the engine 17 is allowed to start. This feature may be useful when the engine 17 has to be warmed under severe cold weather or other condition. However, once an occupant has gotten into the vehicle and sat in the seat in the vehicle to turn OFF the seat occupancy detector 15, the seatbelt safety device according to the present invention becomes operative so that the engine 17 will not start unless the occupant wear the seatbelt.

The driver or occupant may unfasten the seatbelt at toll gates or other places or may shift in the seat during the driving so that the electric circuit would respond to any changes in the seat buckle switch or sensor 14 or the seat occupancy detector 15. According to the preferred embodiment of the present invention, this potential risk of malfunction or erroneous operation will be avoided by providing a short circuit 19 including a short-circuit relay. Once the engine 17 has started, a coil 20 of the short circuit relay 19 is energized to keep the short circuit relay ON so that the engine 17 keeps moving even though the seat buckle detector 14 or seat occupancy detector 15 changes in status during driving. A voice IC 21 is also provided to sound an alert when the occupant is sitting in the seat but without wearing the seatbelt 11.

As discussed above, when the occupant sits in a seat, the seat occupancy detector 15 to detect whether a passenger is sitting in the seat is activated, cutting off the electrical circuit, therefore not allowing the engine 17 to start when starter switch 18 is activated and the vehicle would not move. But when the seatbelt 11 is worn, the seat buckle detector 14 is activated and connects the electrical circuit, the engine 17 is allowed to start and the vehicle may move. If the seatbelt 11 is unfastened while the vehicle is in motion, the short circuit relay 19 would not stop the engine 17 but the voice IC 21 would provide a sound warning to fasten the seatbelt, therefore saving human lives in a reliable and faultless manner.

Various other modifications and variations will no doubt occur to those skilled in the arts to which this invention pertains. Such variations and modifications, which generally rely on the teachings through which this disclosure has advanced the art, are properly considered within the scope of this invention. This disclosure should thus be considered illustrative, not limiting; the scope of the invention is instead defined by the following claims.

What is claimed is:

1. A seatbelt safety device for vehicles comprising:
a seat buckle detector responsive to whether a seatbelt is buckled by an occupant in the vehicle;
a seat occupancy detector responsive to whether the occupant is sitting in a seat in the vehicle;
an electric circuit for energizing an engine of the vehicle; the seat buckle detector and the seat occupancy detector being connected in parallel with the electric circuit so that the engine is allowed to move through actions of the seat buckle detector and the seat occupancy detector when the occupant sits and buckles the seatbelt; and
a short circuit connected in the electric circuit for keeping the engine to move once the engine has started.

2. A seatbelt safety device for vehicles comprising:
a seat buckle detector responsive to whether a seatbelt is buckled by an occupant in the vehicle;
a seat occupancy detector responsive to whether the occupant is sitting in a seat in the vehicle;
an electric circuit for energizing an engine of the vehicle; the seat buckle detector and the seat occupancy detector being connected in parallel with the electric circuit so that the engine is allowed to move through actions of the seat buckle detector and the seat occupancy detector when the occupant sits and buckles the seatbelt;
a short circuit connected in the electric circuit for keeping the engine to move once the engine has started; and
a voice IC circuit connected with the electric circuit for providing an alert when the occupant sits but does not buckle the seatbelt.

3. A seatbelt safety device as defined in claim 1 wherein the seat buckle detector comprises an electric ON/OFF switch or sensor.

4. A seatbelt safety device as defined in claim 1 wherein the seat occupancy detector comprises an electric ON/OFF switch or sensor.

5. A seatbelt safety device as defined in claim 1 wherein the seat buckle detector is provided for each of seatbelts in the vehicle for up to a total number of seatbelts in the vehicle.

6. A seatbelt safety device as defined in claim 1 wherein the seat occupancy detector is provided for each of seats in the vehicle for up to a total number of seats in the vehicle.

7. A seatbelt safety device for vehicles comprising:
a plurality of seat buckle detectors responsive to whether an individual seatbelt is buckled by individual occupants in the vehicle;
a plurality of seat occupancy detectors responsive to whether the occupants are sitting in individual seats in the vehicle;
an electric circuit for energizing an engine of the vehicle; the seat buckle detectors being connected in series and the seat occupancy detector being connected in series, the series connection of the seat buckle detectors being connected in parallel with the series connection of the seat occupancy detectors in the electric circuit so that the engine is allowed to move through actions of the seat buckle detectors and the seat occupancy detectors when the occupants sit and buckle the individual seatbelts; and
a short circuit connected in the electric circuit for keeping the engine to move once the engine has started.
